(19) United States
(12) Patent Application Publication
(10) Pub. No.: US 2025/0170989 A1
(43) Pub. Date: May 29, 2025

(54) WIPER ARM DEVICE AND WIPER SYSTEM

(71) Applicant: Robert Bosch GmbH, Stuttgart (DE)

(72) Inventor: Stijn Truyens, Tienen (BE)

(21) Appl. No.: 18/834,401

(22) PCT Filed: Mar. 1, 2023
(86) PCT No.: PCT/EP2023/055172

§ 371 Date: Jul. 30, 2024

(30) Foreign Application Priority Data
Mar. 3, 2022 (DE) 10 2022 202 184.3

(51) Int. Cl. B60S 1/34; B60S 1/38; B60S 1/40

(52) U.S. Cl. CPC B60S 1/3415; B60S 1/3862; B60S 1/407

(57) ABSTRACT

The invention is based on a wiper arm device (10) comprising at least one wiper arm adapter (14) for coupling to at least one wiper blade (102) and to at least one fluid supply unit (24) in order to supply the at least one wiper blade (102) with wiper fluid, which unit comprises at least one fluid line (26).

It is proposed that the fluid supply unit (24) comprises a coupling unit (16), which is designed as a headpiece for the at least one fluid line (26) and which comprises at least two coupling elements (20, 22) which are designed for a mechanical connection to the at least one wiper blade (102), and wherein exactly one coupling element (20) of the at least two coupling elements (20, 22) is designed for a fluidic connection to the at least one wiper blade (102).

### BACKGROUND

Previously proposed is a wiper arm device comprising at least one wiper arm adapter for coupling to at least one wiper blade and to at least one fluid supply unit for supplying the at least one wiper blade with wiper fluid, which unit comprises at least one fluid line.

### SUMMARY

The invention is based on a wiper arm device comprising at least one wiper arm adapter for coupling to at least one wiper blade and to at least one fluid supply unit in order to supply the at least one wiper blade with wiper fluid, which device comprises at least one fluid line.

It is proposed that the fluid supply unit comprises a coupling unit which is designed as a headpiece for the at least one fluid line and which comprises at least two coupling elements which are designed for a mechanical connection to the at least one wiper blade and whereby exactly one coupling element of the at least two coupling elements is designed for a fluidic connection to the at least one wiper blade.

The term “wiper arm device” is preferably intended to mean at least one part, preferably one subassembly, of a windshield wiper. The wiper arm device can preferably also comprise the entire windshield wiper, in particular comprising a wiper blade. The wiper arm device is preferably provided for use on a vehicle. The wiper arm device preferably forms a part of the windshield wiper, in particular at least one wiper rod comprising a wiper arm adapter, between a wiper drive and a wiper blade. The wiper arm device, in particular as part of the windshield wiper, is preferably provided for cleaning a surface, preferably a surface of a window on a vehicle. The wiper arm device is preferably coupled to a vehicle, preferably the wiper drive of a vehicle, for cleaning a surface of a vehicle windshield. The expression “object being provided for a specific function” is preferably intended to mean that the object fulfils and/or performs this specific function in at least one application and/or operating state. The term “operating state” is preferably intended to mean a state in which the wiper arm device is ready for a wiping process and/or a wiping operation and/or is in a wiping operation in which a wiper strip unit, preferably the wiper lip, of the wiper blade, in particular of the windshield wiper, is preferably guided over the surface of the vehicle windshield and advantageously rests against the surface of the vehicle windshield.

The wiper arm device preferably comprises at least one wiper rod. The wiper rod is preferably designed to be integral with the wiper arm adapter. The term “integral” is in particular intended to mean a bonded connection, in particular formed as one piece, whereby the one piece is preferably produced from a single blank, a mass, and/or a casting, particularly preferably in an injection molding process, in particular a single and/or multi-component injection molding process. The wiper rod is preferably made of a metal material. The wiper arm adapter is preferably made of the same material as the wiper rod. The wiper arm adapter is preferably designed as a side-lock adapter. The wiper arm adapter preferably comprises at least one pin element.

The at least one fluid supply unit is preferably designed to guide wiper fluid, in particular wiping water, along the wiper rod from an end of the wiper rod facing away from the wiper arm adapter to the wiper arm adapter, in particular to the wiper blade. The fluid supply unit is preferably arranged at least for the most part in a cavity delimited by the wiper rod. Preferably, the at least one fluid supply unit comprises precisely one fluid line, in particular precisely one hose element, for supplying the wiper blade. Preferably, the exactly one fluid line, in particular the exactly one hose element, extends along a longitudinal axis of the wiper rod from an end of the wiper rod facing away from the wiper arm adapter to the wiper arm adapter, in particular to the wiper blade. A longitudinal axis of the fluid line, in particular of the hose element, is preferably at least substantially parallel to a longitudinal axis of the wiper rod. The term “longitudinal axis” of an object is in particular intended to mean an axis which extends parallel to a longest edge of a smallest geometric cuboid which just completely encloses the object and preferably extends through a geometric center of the object, in particular the cuboid.

In this context, the term “substantially parallel” is in particular intended to mean an orientation of a direction relative to a reference direction, in particular in a plane, whereby the direction has a deviation from the reference direction of in particular less than 15°, advantageously less than 10°, and in particular advantageously less than 5°.

The coupling is preferably connected to the hose element, in particular fluidically. The coupling is preferably designed as an end piece, in particular a headpiece, for the fluid line, in particular the hose element, at an end of the fluid line, in particular the hose element, facing the wiper arm adapter. The at least two coupling systems are preferably designed to be the same size. The at least two coupling elements are preferably designed to have the same shape. The at least two coupling systems are arranged at a distance from one another.

The coupling unit preferably comprises at least two suspension extensions for mounting on the wiper arm adapter. Preferably, the at least two suspension extensions are arranged on opposite sides of the coupling unit. The at least two suspension extensions are preferably arranged in alignment along a longitudinal axis of the pin element. Preferably, the wiper arm adapter comprises a cover element which is pivotably connected to the pin element. The cover element preferably comprises two suspension recesses which are opposite each other along the longitudinal axis of the pin element. Preferably, the at least two suspension extensions are designed to be connected to the cover element, in particular to the at least two suspension recesses.

The longitudinal axis of the pin element is preferably at least substantially perpendicular to the longitudinal axis of the wiper rod and/or the wiper arm adapter. In this context, the term “substantially perpendicular” is in particular intended to mean an orientation of a direction relative to a reference direction, whereby, in particular viewed in a projection plane, the direction and the reference direction enclose an angle of 90° and the angle has a maximum deviation of in particular less than 8°, advantageously less than 5° and particularly advantageously less than 2°.

The coupling unit preferably delimits exactly one fluid channel. Preferably, one of the coupling elements delimits a part of the fluid channel. Preferably, the fluid channel is fluidically separated from one of the coupling elements. Preferably, the fluid channel is formed as a cavity in the coupling unit. Preferably, at least one coupling element is solid, in particular free of cavities.

The coupling is preferably designed, in particular manufactured, to be integral, or as two parts. The term “integral” is in particular intended to mean formed in one piece, whereby the one piece is preferably produced from a single blank, a mass and/or a casting, particularly preferably in an injection molding process, in particular a single and/or multi-component injection molding process.

Particularly preferably, the coupling unit is originally designed as two separate parts, in particular manufactured as a coupling base body and a channel cover. The coupling base bodies and a channel cover are preferably designed to be connected to each other in a bonded manner, e.g. by ultrasonic welding and/or by bonding. Alternatively, the coupling base bodies and a channel cover can be connected, in particular connectable, by a snap-in mechanism. The coupling base bodies and a channel cover are preferably connected to each other in a bonded manner. The at least two coupling systems are arranged on the coupling base body. Preferably, the fluid channel in the coupling unit is partially delimited by the coupling base body and partially delimited by the channel cover. The channel cover is preferably arranged on a side of the coupling base body facing away from the at least two coupling elements, in particular connected to the coupling base body. The channel cover preferably extends over at least 50%, preferably over at least 60%, in particular over at least 75%, of a maximum extension of the fluid channel along a longitudinal axis of the fluid channel.

The embodiment of the wiper arm device according to the invention is able to achieve an advantageous freedom of movement of the wiper arm device. The rotational freedom of movement of the wiper rod in particular can be advantageously increased. In particular, a torque of the wiper arm device can be advantageously reduced. In particular, friction between the fluid line and the wiper rod can be advantageously reduced.

It is further proposed that the at least two coupling elements are designed to form a mechanical plug-in connection with the at least one wiper blade. One of the at least two coupling elements preferably delimits the fluid channel to a circular outer contour in a cross-section perpendicular to a plug-in axis of the at least one coupling element. Preferably, the at least two coupling elements for a mechanical plug-in connection have a maximum extension along a plug-in axis of the at least two coupling elements, which is intended to be plugged at least halfway into at least one recess on the wiper blade. The at least two coupling elements can be designed as plug-in recesses, in particular to accommodate plug-in extensions of the wiper blade. A mechanical and fluidic connection of the coupling unit to the wiper blade can be achieved advantageously quickly.

It is also proposed that the at least two coupling elements are designed as plug-in extensions. The at least two coupling systems are designed as cylindrical elements. The at least two coupling elements preferably have a circular outer contour in a cross-section perpendicular to a longitudinal axis of the at least two coupling elements. The at least two coupling elements preferably have a smaller diameter at a respective free end of the at least two coupling elements than at a connecting end of the at least two coupling elements. The at least two coupling elements preferably each comprise two regions, which extend along the plug-in axis at a constant diameter. The at least two coupling elements preferably each comprise a central region, which extends along the plug-in axis at a linearly varying diameter. A connection of the coupling unit to the wiper blade that is advantageously secured against rotation about the plug-in axis of the at least two coupling elements can be achieved.

It is further proposed that a coupling unit comprises at least one supply coupling element for a connection to the at least one fluid line, which has a connection direction that is oriented at least substantially perpendicular to the connection directions of the at least two coupling elements. The at least one supply coupling element is preferably designed as an elongated plug-in extension, in particular a connecting nozzle. The at least one supply coupling element is preferably designed to be plugged into the fluid line, in particular into the hose element. The at least one supply coupling element is preferably chamfered at a free end of the at least one supply coupling element to form a blunt tip. The at least one supply coupling element is preferably tapered behind the blunt tip. The at least one supply coupling element preferably has a maximum extension in the connection direction, in particular in the plug-in direction, of the at least one supply coupling element, which is at least as long as a maximum extension of the at least two coupling elements along the plug-in axes of the at least two coupling elements. Preferably, the connection direction of the at least one supply coupling element is oriented at least substantially parallel to a longitudinal axis of the wiper rod, the wiper arm device, the wiper arm adapter and/or the wiper blade. Preferably, the connection direction of the at least one supply coupling element is oriented at least substantially perpendicular to the longitudinal axis of the pin element. The fluid supply unit, in particular the fluid line, can be advantageously guided at a distance from the walls of the wiper rod. In particular, the fluid supply unit can be advantageously arranged on the wiper rod with low wear.

It is further proposed that a coupling unit comprises at least one supply coupling element for a connection to the at least one fluid line, which is fluidically connected to a coupling element of the at least two coupling elements. The at least one supply coupling element preferably at least partially delimits the fluid channel. The supply coupling element is preferably designed for a fluidic connection with the fluid supply unit. The at least one supply coupling element is preferably arranged along a connecting axis, which is oriented parallel to an imaginary shortest straight connecting lines between the two coupling elements, offset relative to the coupling element of the at least two coupling elements, which is fluidically connected to the at least one supply coupling element. The at least one supply coupling element is preferably arranged along a connection axis, which is oriented parallel to an imaginary shortest straight connecting line between the two coupling elements, not offset relative to coupling element of the at least two coupling elements, which is connected purely mechanically to the at least one supply coupling element and which in particular does not delimit a cavity. An advantageous mechanical connectivity of the coupling unit on both sides can be achieved. In particular, a connection of the coupling unit with the wiper blade and the fluid supply unit that is advantageously fixed in position, especially in terms of rotation, can be achieved.

It is further proposed that a coupling unit comprises at least one supply coupling element for a connection to the at least one fluid line, which is fluidically connected to a coupling element of the at least two coupling elements, which is arranged at a greater distance from the at least one supply coupling element. The at least one supply coupling element is preferably only mechanically connected to a coupling element of the at least two coupling elements, which is arranged closer to the at least one supply coupling element. Preferably, the fluid channel is delimited to an at least substantially S-shaped or 2-shaped course when viewed along the plug-in axis of the at least two coupling elements. Preferably, the at least one supply coupling element partially delimits a region of the fluid channel in which the fluid channel is angled by at least 45°, preferably perpendicularly. Preferably, the at least one coupling element delimits a part of the fluid channel that has a straight course. Preferably, the coupling unit, in particular a fluid bridge element of the coupling unit, between the supply coupling element and the at least one coupling element, which is in particular fluidically connected to the supply coupling element, delimits the fluid channel to a curved, in particular rounded curved, in particular by at least 45°, preferably by 90°. An advantageously one-sided fluid output on the wiper blade can be achieved, whereby a two-sided fluid output design of a wiper blade can advantageously continue to be used unchanged and whereby the fluid supply unit is advantageously arranged to protect the material.

It is further proposed that the coupling unit comprises at least one bridge element which connects the at least two coupling elements and which is arranged at least partially between the at least two coupling elements. Preferably, the bridge element is designed as a solid element, in particular without cavities. The at least two coupling systems are arranged at a distance from one another along the longitudinal axis of the pin element. Preferably, the at least one bridge element extends along the longitudinal axis of the pin element between the at least two coupling elements from one coupling element to the other coupling element. Preferably, a longitudinal axis of the bridge element is at least substantially parallel to a longitudinal axis of the pin element. Preferably, the at least one bridge element is formed differently from the at least one fluid bridge element. Preferably, the coupling unit comprises the fluid bridge element. An advantageously robust coupling unit can be achieved.

In addition, a wiper system is proposed with at least one wiper blade and with at least one wiper arm device according to the invention. The wiper blade preferably comprises a wind deflector unit. Preferably, the wind deflector unit comprises two spoiler elements. Preferably, the spoiler elements are arranged on sides of the wiper blade adapter facing away from each other along the longitudinal axis of the wiper blade. The wiper blade preferably comprises a wiper strip unit, which is partially designed to be the wiper lip. Preferably, the wiper strip unit is made of an elastomer material. The wiper blade preferably comprises two end caps. The wiper blade preferably comprises at least one spring rail. The wiper blade preferably comprises at least two spring rails. The wiper blade preferably comprises at least one wiper blade adapter. Preferably, the wiper blade adapter comprises at least two coupling recesses for a connection with the coupling unit, in particular with the at least two coupling elements. Preferably, the at least two coupling recesses are arranged on a side of the wiper blade adapter that faces away from the wiper lip. An advantageous compatibility of wiper blade and wiper arm device can be achieved.

It is further proposed that the at least one wiper blade comprises at least two fluid channel units that are fluidically separated from each other, of which exactly one is fluidically connected to the coupling unit. The two coupling recesses of the wiper blade adapter are preferably each connected to one of the two fluid channel units. In particular, it can be achieved that the coupling recesses for the respective fluid channel units can be used for a connection to the coupling unit. An advantageous fluid output can be achieved at the wiper blade.

It is further proposed that the at least one wiper arm adapter comprises at least one pin element for a pivotable connection to the wiper blade, whereby the at least one wiper blade comprises at least two fluid channel units which are fluidically separated from each other, the free end of one of which is fluidically connected to the coupling unit via the fluid channel unit, which is arranged facing the at least one pin element. Preferably, the fluid channel unit of the at least two fluid channel units of the wiper blade is fluidically connected to the coupling unit, which is arranged facing a wiping side of the wiper blade, whereby the wiping side is defined in particular with respect to a vehicle windshield on which the wiper system is arranged. The wiping side is preferably a side of the wiper blade facing the free end of the at least one pin element. An advantageously oriented fluid output can be achieved.

In addition, a coupling unit of a wiper arm device according to the invention is proposed. An advantageous spare part characteristic of the coupling unit can be achieved.

The wiper arm device according to the invention and/or the wiper system according to the invention should not be limited to the application and embodiment described above. In particular, the wiper arm device according to the invention and/or the wiper system according to the invention can comprise a number of individual elements, components, and units that deviates from a number specified herein in order to fulfill a mode of operation described herein. Moreover, regarding the ranges of values indicated in this disclosure, values lying within the limits specified hereinabove are also intended to be considered as disclosed and usable as desired.

### BRIEF DESCRIPTION OF THE DRAWINGS

Further advantages follow from the description of the following drawings. The drawings illustrate an exemplary embodiment of the invention. The drawing, the description, and the claims contain numerous features in combination. The skilled person will appropriately also consider the features individually and combine them into additional advantageous combinations.

Shown are:

FIG. 1 a wiper system according to the invention comprising a wiper arm device according to the invention and a wiper blade in a schematic, partially transparent representation,

FIG. 2 a coupling unit of the wiper arm device according to the invention in a schematic representation and

FIG. 3 a schematic representation of the coupling unit of the wiper arm device according to the invention.

### DETAILED DESCRIPTION

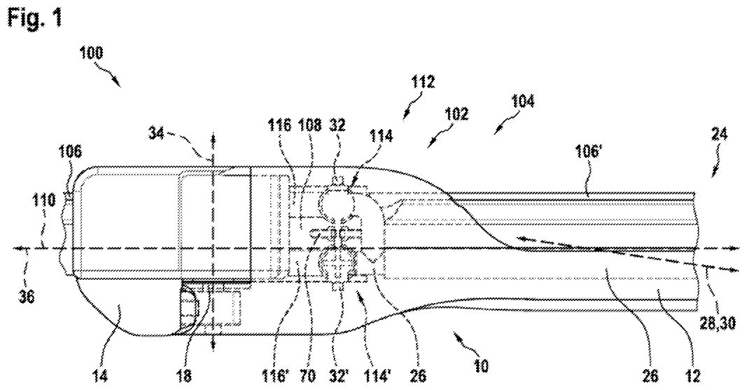

FIG. 1 shows a wiper system 100. The wiper system 100 comprises a wiper blade 102. The wiper system 100 comprises a wiper arm device 10.

The wiper blade 102 comprises a wind deflector unit 104. The wind deflector unit 104 comprises two spoiler elements 106, 106′. The wiper blade 102 comprises a wiper blade adapter 108. The spoiler elements 106, 106′ are arranged on sides of the wiper blade adapter 108 facing away from each other along a longitudinal axis 110 of the wiper blade 102.

The wiper blade 102 comprises a wiper strip unit 112, which is partially formed as the wiper lip (not shown). The wiper strip unit 112 is made of an elastomer material. The wiper blade 102 comprises two end caps (not shown). The wiper blade 102 comprises two spring rails (not shown). The wiper blade adapter 108 comprises two coupling recesses 114, 114′ for connection to a coupling unit 16, in particular to two coupling elements 20, 22. The two coupling recesses 114, 114′ are arranged on one side of the wiper blade adapter 108, which is arranged facing away from the wiper lip.

FIG. 1 shows in particular the wiper blade 102, which comprises two fluidically separate fluid channel units 116, 116′, exactly one of which is fluidically connected to the coupling unit 16. The two coupling recesses 114, 114′ of the wiper blade adapter 108 are each connected to one of the two fluid channel units 116, 116′.

The wiper arm device 10 comprises a wiper rod 12. The wiper arm device 10 comprises a wiper arm adapter 14 for coupling with the wiper blade 102. The wiper arm device 10 comprises a fluid supply unit 24 for supplying the wiper blade 102 with wiper fluid. The fluid supply unit 24 comprises a fluid line 26, which is arranged in particular on the wiper rod 12.

The fluid supply unit 24 comprises the coupling unit 16. The coupling unit 16 is designed as a headpiece for the fluid line 26. The coupling unit 16 comprises two coupling elements 20, 22. The coupling elements 20, 22 are designed to form a mechanical connection with the wiper blade 102, in particular the wiper blade adapter 108. Exactly one coupling element 20 of the two coupling elements 20, 22 is designed for a fluidic connection with the wiper blade 102.

The wiper arm device 10 is a sub-assembly of a windshield wiper. The wiper arm device 10 is intended for use on a vehicle. The wiper arm device 10 forms part of the windshield wiper between a wiper drive and the wiper blade 102. The wiper arm device 10 is coupled to the vehicle, in particular the wiper drive of a vehicle, to clean the surface of a vehicle windshield.

The wiper rod 12 is connected to the wiper arm adapter 14 in a bonded manner. The wiper rod 12 is in particular manufactured to be integral with the wiper arm adapter 14. The wiper rod 12 is made of a metal material. The wiper arm adapter 14 is made of the same material as the wiper rod 12. The wiper arm adapter 14 is designed as a side-lock adapter. The wiper arm adapter 14 comprises a pin element 18. The pin element 18 is pivotably connected to the wiper blade 102.

The fluid supply unit 24 is designed to guide wiper fluid, in particular wiping water, along the wiper rod 12 from an end of the wiper rod 12 facing away from the wiper arm adapter 14 to the wiper arm adapter 14, in particular to the wiper blade 102. The fluid supply unit 24 is largely arranged in a cavity delimited by the wiper rod 12. The fluid supply unit 24 comprises exactly one fluid line 26, in particular exactly one hose element, for supplying the wiper blade 102. The exactly one fluid line 26, in particular the exactly one hose element, extends along a longitudinal axis 28 of the wiper rod 12 from an end of the wiper rod 12 facing away from the wiper arm adapter 14 to the wiper arm adapter 14, in particular to the wiper blade 102. A longitudinal axis 30 of the entire fluid line 26, in particular of the hose element, is parallel to the longitudinal axis 28 of the entire wiper rod 12 except for a maximum deviation of 10°.

The coupling unit 16 is connected to the fluid line 26, in particular the hose element, in particular fluidically. The coupling unit 16 is designed as an end piece, in particular a headpiece, for the fluid line 26, in particular the hose element, at an end of the fluid line 26, in particular of the hose element, facing the wiper arm adapter 14.

The two coupling elements 20, 22 are designed to have the same size. The two coupling elements 20, 22 are designed to have the same shape. The two coupling elements 20, 22 are arranged at a distance from each other.

The coupling unit 16 comprises two suspension extensions 32, 32′ for mounting on the wiper arm adapter 14. The two suspension extensions 32, 32′ are arranged on opposite sides of the coupling unit 16.

The two suspension extension 32, 32′ are arranged in alignment along a longitudinal axis 34 of the pin element 18. The wiper arm adapter 14 comprises a cover element (not shown), which is pivotably connected to the pin element 18. The cover element comprises two suspension recesses, which lie opposite each other along the longitudinal axis 34 of the pin element 18. The two suspension extensions 32, 32′ are designed to be connected to the cover element, in particular to the two suspension recesses.

The longitudinal axis 34 of the pin element 18 is perpendicular to the longitudinal axis 28 of the wiper rod 12 and/or to a longitudinal axis 36 of the wiper arm adapter 14, except for deviations of a maximum of 10°.

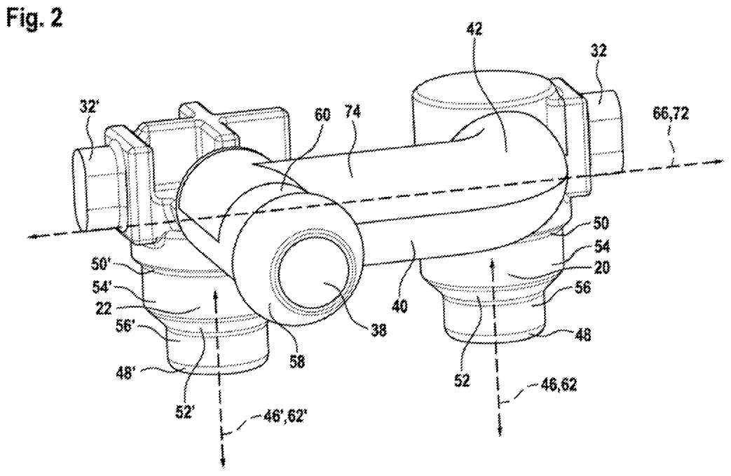

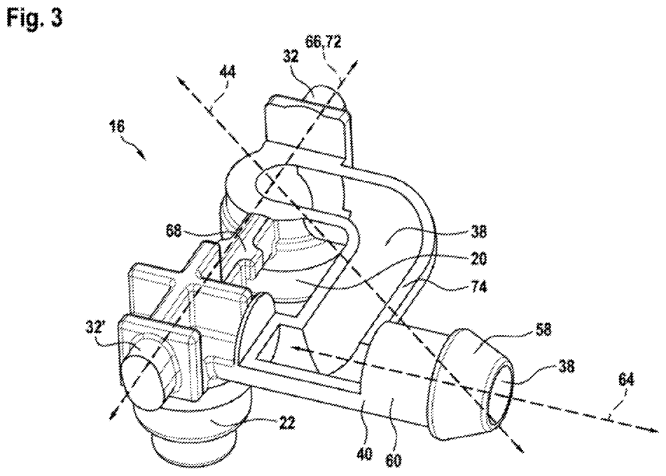

FIGS. 2 and 3 show the coupling unit 16 in more detail. The coupling unit 16 delimits exactly one fluid channel 38. A coupling element 20 of the two coupling elements 20, 22 delimits a part of the fluid channel 38. The fluid channel 38 is fluidically separated from a coupling element 22 of the two coupling elements 20, 22. The fluid channel 38 is formed as a cavity in the coupling unit 16. Exactly one coupling element 22 of the two coupling elements 20, 22 is solid, in particular free of cavities.

The coupling unit 16 is formed in two parts, in particular manufactured. The coupling unit 16 is originally designed as two separate parts, in particular manufactured as a coupling base body 40 and a channel cover 42. The coupling base body 40 and the channel cover 42 are designed to be connected to each other in a bonded manner, e.g. by ultrasonic welding and/or by bonding. The coupling base body 40 and the channel cover 42 are connected to each other in a bonded manner.

The two coupling elements 20, 22 are arranged on the coupling base body 40. The fluid channel 38 in the coupling unit 16 is partially delimited by the coupling base body 40 and partially delimited by the channel cover 42.

The channel cover 42 is arranged on a side of the coupling base body 40 facing away from the two coupling elements 20, 22, in particular connected to the coupling base body 40. The channel cover 42 extends over at least 50% of a maximum extension of the fluid channel 38 along a longitudinal axis 44 of the fluid channel 38.

The two coupling elements 20, 22 are designed to form a mechanical plug-in connection with the wiper blade 102, in particular the wiper blade adapter 108. A coupling element 20 of the two coupling elements 20, 22 delimits the fluid channel 38 to a circular outer contour in a cross-section perpendicular to an plug-in axis 46, 46′ of the coupling element 20. The two coupling elements 20, 22 comprise parallel plug-in axes 46, 46′.

For a mechanical plug-in connection, the two coupling elements 20, 22 have a maximum extension along the plug-in axis 46, 46′ of the two coupling elements 20, 22, which is intended to be plugged at least halfway into one of the two coupling recesses 114, 114′ on the wiper blade 102 in each case. The two coupling elements 20, 22 are designed as plug-in extensions.

The two coupling elements 20, 22 are designed as cylindrical elements. The two coupling elements 20, 22 feature a circular outer contour in a cross-section perpendicular to the plug-in axis 46, 46′ of the two coupling elements 20, 22. The two coupling elements 20, 22 feature a smaller diameter at a respective free end 48, 48′ of the two coupling elements 20, 22 than at a connecting end 50, 50′ of the two coupling elements 20, 22. The two coupling elements 20, 22 each comprise two regions 54, 56, 54′, 56′, which extend along the plug-in axis 46, 46′ at a constant diameter. The two coupling elements 20, 22 each comprise a central region 52, 52′, which extends along the plug-in axis 46, 46′ at a linearly varying diameter.

The coupling unit 16 comprises a supply coupling element 60. The supply coupling element 60 is designed to be connected to the fluid line 26. The supply coupling element 60 has a connection direction 64 which is oriented perpendicular to the connection directions 62, 62′, in particular to the plug-in axes 46, 46′, of the two coupling elements 20, 22 (see FIG. 3). The connection direction 64 of the supply coupling element 60 is oriented parallel to the longitudinal axis 28, 30, 110 of the wiper rod 12, the wiper arm device 10, the wiper arm adapter 14 and/or the wiper blade 102, except for a maximum deviation of 10°. The connection direction 64 of the supply coupling element 60 is oriented perpendicular to the longitudinal axis 34 of the pin element 18.

The supply coupling element 60 is designed as an elongated plug-in extension, in particular as a connecting nozzle. The supply coupling element 60 is designed to be plugged into the fluid line 26, in particular into the hose element. The supply coupling element 60 is chamfered at a free end 58 of the supply coupling element 60 to form a blunt tip. The supply coupling element 60 is tapered behind the blunt tip. The supply coupling element 60 has a maximum extension in the connection direction 64, in particular in the plug-in direction, of the supply coupling element 60, which is at least as long as a maximum extension of the two coupling elements 20, 22 along the plug-in axes 46, 46′ of the two coupling elements 20, 22.

The supply coupling element 60 is fluidically connected to a coupling element 20 of the two coupling elements 20, 22. The supply coupling element 60 at least partially delimits the fluid channel 38. The supply coupling element 60 is designed for a fluidic connection with the fluid supply unit 24. The supply coupling element 60 is arranged along a connecting axis 66, which is oriented parallel to an imaginary shortest straight connecting lines between the two coupling elements 20, 22, offset with respect to the coupling element 20 of the two coupling elements 20, 22, which is fluidically connected to the supply coupling element 60.

The supply coupling element 60 is arranged along a connecting axis 66, which is oriented parallel to an imaginary shortest straight connecting lines between the two coupling elements 20, 22, not offset relative to the coupling element 22 of the two coupling elements 20, 22, which is connected purely mechanically to the supply coupling element 60 and which in particular does not delimit a cavity.

The supply coupling element 60 is fluidically connected to the coupling element 20 of the two coupling elements 20, 22, which is arranged at a greater distance from the supply coupling element 60. The supply coupling element 60 is only mechanically connected to the coupling element 22 of the two coupling elements 20, 22, which is arranged closer to the supply coupling element 60.

The fluid channel 38 is delimited to an at least substantially S-shaped or 2-shaped course when viewed along the plug-in axes 46, 46 of the two coupling elements 20, 22. The supply coupling element 60 partially delimits a region of the fluid channel 38 in which the fluid channel 38 is angled by at least 45°, in particular perpendicularly.

The coupling element 20 of the two coupling elements 20, 22 delimits a part of the fluid channel 38, which has a rectilinear course. The coupling unit 16, in particular a fluid bridging element 74 of the coupling unit 16, delimits the fluid channel 38 between the supply coupling element 60 and the coupling element 20, which is in particular fluidically connected to the supply coupling element 60, to a curved, in particular rounded curved, in particular by 90°, course.

The coupling unit 16 comprises a bridge element 68. The bridge element 68 connects the two coupling elements 20, 22. The bridge element 68 is partially arranged between the two coupling elements 20, 22. The bridge element 68 is designed as a solid element, in particular without cavities. The two coupling elements 20, 22 are arranged at a distance from one another along the longitudinal axis 34 of the pin element 18.

The bridge element 68 extends along the longitudinal axis 34 of the pin element 18 between the two coupling elements 20, 22 from one coupling element 20, 22 to the other coupling element 20, 22. A longitudinal axis 72 of the bridge element 68 is parallel to the longitudinal axis 34 of the pin element 18. The longitudinal axis 72 of the bridge element 68 is parallel to the connection axis 66. The bridge element 68 is formed differently from the fluid bridge element 74. The coupling unit 16 comprises the fluid bridge element 74.

The wiper blade adapter 108 comprises a latching element 70, which is intended to receive the bridge element 68 for a snap-in mechanism with the bridge element 68 (see FIG. 1).

A fluid channel unit 116 of the two fluid channel units 116, 116′, which unit is arranged facing a free end of the pin element 18, is fluidically connected to the coupling unit 16.

The fluid channel unit 116 of the two fluid channel units 116, 116′ of the wiper blade 102, which unit is arranged facing a wiping side of the wiper blade 102 (whereby the wiping side is defined in particular with respect to a vehicle windshield on which the wiper system 100 is arranged) is fluidically connected to the coupling unit 16. The wiping side is a side of the wiping blade 102 arranged to face a free end of the pin element 18.

1. A wiper arm device comprising at least one wiper arm adapter (14) for coupling to at least one wiper blade (102) and to at least one fluid supply unit (24) to supply the at least one wiper blade (102) with wiper fluid, which unit comprises at least one fluid line (26), wherein the fluid supply unit (24) comprises a coupling unit (16), which is configured as a headpiece for the at least one fluid line (26) and which comprises at least two coupling elements (20, 22) which are configured for a mechanical connection to the at least one wiper blade (102), and wherein exactly one coupling element (20) of the at least two coupling elements (20, 22) is configured for a fluidic connection to the at least one wiper blade (102).

2. The wiper arm device according to claim 1, wherein the at least two coupling elements (20, 22) are configured for a mechanical plug-in connection to the at least one wiper blade (102).

3. The wiper arm device according to claim 1, wherein the at least two coupling elements (20, 22) are configured as plug-in extensions.

4. The wiper arm device according to claim 1, wherein the coupling unit (16) comprises at least one supply coupling element (60) for a connection to the at least one fluid line (26), which supply coupling element has a connection direction (64) that is oriented at least substantially perpendicular to connection directions (62, 62′) of the at least two coupling elements (20, 22).

5. The wiper arm device according to claim 1, wherein the coupling unit (16) comprises at least one supply coupling element (60) for a connection to the at least one fluid line (26), which supply coupling element is fluidically connected to a coupling element (20) of the at least two coupling elements (20, 22).

6. The wiper arm device according to claim 1, wherein the coupling unit (16) comprises at least one supply coupling element (60) for a connection to the at least one fluid line (26), which supply coupling element is fluidically connected to a coupling element (20) of the at least two coupling elements (20, 22) and is further arranged at a distance from the at least two coupling elements (20, 22).

7. The wiper arm device according to claim 1, wherein the coupling unit (16) comprises at least one bridge element (68), which connects the at least two coupling elements (20, 22) and which is arranged at least partially between the at least two coupling elements (20, 22).

8. A wiper system comprising at least one wiper blade (102) and comprising at least one wiper arm device (10) according to claim 1.

9. The wiper system according to claim 8, wherein the at least one wiper blade (102) comprises at least two fluid channel units (116, 116′), which are fluidically separated from each other and of which exactly one is fluidically connected to the coupling unit (16).

10. The wiper system according to claim 8, wherein the at least one wiper arm adapter (14) comprises at least one pin element (18) for a pivotable connection to the wiper blade (102), wherein the at least one wiper blade (102) comprises at least two fluid channel units (116, 116′) which are fluidically separated from each other, the free end of one of which is fluidically connected to the coupling unit (16) via the fluid channel unit (116), which is arranged facing the at least one pin element (18).

11. A coupling unit of a wiper arm device (10) according to claim 1.
